(19) United States
(12) Patent Application Publication
(10) Pub. No.: US 2026/0013687 A1
(43) Pub. Date: Jan. 15, 2026

(54) AIR-POWERED CLEANING DEVICE NOZZLE

(71) Applicant: BLOWER BLADE PTY LTD, Sylvania (AU)

(72) Inventors: Danny Agius, Sylvania (AU); Peter Ishak, Sylvania (AU); Tony Cakarun, Sylvania (AU)

(21) Appl. No.: 19/266,471

(22) Filed: Jul. 11, 2025

(30) Foreign Application Priority Data
Jul. 12, 2024 (AU) 2024902154

(51) Int. Cl. A47L 9/08; A47L 9/06; A47L 9/24; B05B 1/00; E04D 13/076

(52) U.S. Cl. CPC A47L 9/08; A47L 9/0626; A47L 9/242; B05B 1/005; E04D 13/0765

(57) ABSTRACT

A nozzle for a blower tube includes a collar configured to attach to the distal end of the blower tube and a blade defining a scraping edge. The blade transects the collar, forming top and second outlets that direct respective streams of air along both surfaces of the blade. The first outlet may have a greater cross-section than the second outlet, enhancing airflow distribution. The nozzle may feature a rounded bottom surface of the blade adjacent to the scraping edge and a relatively planar top surface. The collar may consist of adjustable, bifurcated portions for a secure fit. Additionally, a funnel downstream of the collar may funnels air against the blade's surfaces, and channelling formations on the blade's surface may help direct airflow. Internal vanes within the collar may further optimise air distribution across the blade.

### FIELD OF THE INVENTION

The present disclosure relates to the field of air-powered cleaning devices, specifically nozzles designed to enhance the efficiency and effectiveness of debris removal when used in conjunction with blower tubes.

### BACKGROUND OF THE INVENTION

In the field of air-powered cleaning devices, there is a continual need for improvements that enhance the efficiency and effectiveness of debris removal.

Conventional blower tubes are often limited in their ability to dislodge and remove stubborn debris from various surfaces, particularly in confined or hard-to-reach areas such as gutters. Existing solutions may not provide the necessary focus and direction of airflow required to effectively clear debris, leading to suboptimal performance and increased effort for users.

The present invention seeks to provide a way to overcome or substantially ameliorate at least some of the deficiencies of the prior art, or to at least provide an alternative.

### SUMMARY OF THE DISCLOSURE

The present disclosure provides a nozzle configured for attachment to the distal end of a blower tube, wherein the nozzle includes a collar and a blade that transects the collar to form a top outlet and a second outlet. These outlets are arranged to direct separate streams of air along the respective upper and lower surfaces of the blade. At the distal end of the blade, a scraping edge is defined to engage debris during operation.

By dividing airflow into distinct paths along both surfaces of the blade and converging them at the scraping edge, the nozzle produces a concentrated and cooperative flow effect that enhances removal of debris. The upper airflow path helps maintain the blade's top surface clear of build-up while contributing to dislodgement, while the lower stream helps lift and expel loosened material from beneath. This dual-path arrangement improves clearance of stubborn debris that may not respond to airflow alone, particularly in hard-to-reach or irregular surfaces.

The configuration allows for efficient use of air pressure without requiring mechanical complexity or powered moving parts. The nozzle's structure integrates aerodynamic features that guide and concentrate the air while facilitating straightforward attachment to existing blower equipment, making it suitable for both general cleaning and targeted applications such as gutter maintenance.

In some arrangements, the top outlet may have a larger cross-sectional area than the second outlet. This configuration may promote greater airflow along the upper surface of the blade, assisting in keeping the blade clear of debris and increasing the momentum of the converging airflow at the scraping edge.

The lower surface of the blade adjacent the scraping edge may optionally be rounded. Such a profile can ease movement of the nozzle across rough or uneven surfaces, reducing snagging and improving handling during use. In contrast, the upper surface may be relatively planar, which can help maintain a consistent orientation and effective scraping angle.

The collar may comprise bifurcated portions that allow it to be tightened around the distal end of a blower tube. Fastener apertures in these portions may accommodate screw fixings, enabling compatibility with a range of blower tube diameters and providing a stable fit even under operational air pressure.

In some examples, the nozzle includes a funnel downstream of the collar. This structure may serve to direct and compress airflow more precisely against the surfaces of the blade, improving the impact of the air streams at the scraping edge.

At least one of the blade surfaces may incorporate channelling formations that guide the airflow towards the scraping edge. Where the blade widens from the collar toward the distal end, these formations may diverge laterally, helping to spread airflow evenly across the blade width and ensuring that the cleaning effect is not confined to the centreline.

Internal vanes may be provided within the collar to further direct airflow toward the blade surfaces. These vanes may be arranged to account for the changing blade width, redirecting air toward the edges as needed. In some forms, vanes associated with the second outlet may be connected between the collar's interior and the blade's proximal edge, whereas those in the top outlet may be free of contact with the blade, thereby reducing resistance and preserving flow efficiency.

The inner edge of the blade, where it interfaces with the collar, may be convex in profile, forming notches that engage the sides of the blower tube opening. This geometry may help maintain alignment during installation and use, particularly when the airflow exerts dynamic loading on the nozzle.

Scraping edge projections may extend from the side edges of the blade near the scraping edge. These projections may be narrower in cross-section than the adjacent blade portions and shaped to fit within tight surface gaps or corners. In some forms, these projections include forward-facing teeth that can enhance their ability to dislodge embedded or resistant debris.

The nozzle may be provided as part of a system incorporating an adapter. The adapter may include a collar and a cylindrical portion extending therefrom for receiving and interchangeably securing the nozzle. In some versions, the cylindrical portion is bifurcated in line with the collar, allowing it to compress under tightening and hold the nozzle or other attachments firmly without the need for tools.

The cylindrical portion may also taper in cross-section to constrict the airflow path, increasing air velocity as it passes toward the nozzle or elongate extension. This arrangement may be beneficial in applications requiring extended reach or enhanced delivery of air pressure.

Elongate tubes may be attachable to the cylindrical portion of the adapter. These tubes may be held in place using a resilient element, such as a rubber band or elastic sleeve, simplifying attachment and removal while maintaining a reliable seal during operation.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a top perspective view of A nozzle for a blower in accordance with a first embodiment;

FIG. 2 shows a bottom perspective view of the nozzle according to the first embodiment;

FIG. 3 shows a bottom view of the nozzle of the first embodiment;

FIG. 4 shows a side view of the nozzle of the first embodiment;

FIG. 5 shows a rear view of the nozzle according to the first embodiment;

FIG. 6 shows a front view of the nozzle according to the first embodiment;

FIG. 7 shows a top perspective view of A nozzle for a blower in accordance with a second embodiment;

FIG. 8 shows a bottom perspective view of the nozzle according to the second embodiment;

FIG. 9 shows a bottom view of the nozzle according to the second embodiment;

FIG. 10 shows a side view of the nozzle according to the second embodiment;

FIG. 11 shows a rear view of the nozzle according to the second embodiment; and

FIG. 12 shows a front view of the nozzle according to the second embodiment.

FIG. 13 shows a rear view of the nozzle with a collar comprising two pairs of fastener apertures for enhanced clamping.

FIG. 14 shows a side view of a nozzle comprising an elongate tube preceding the blade in accordance with the first embodiment.

FIG. 15 shows a side view of a nozzle comprising an elongate tube preceding the blade in accordance with the second embodiment.

FIG. 16 shows a perspective view of an adapter comprising a collar and a cylindrical portion for receiving a nozzle.

FIG. 17 shows a side view of the adapter of FIG. 16 illustrating the tapering cylindrical portion.

### DESCRIPTION OF EMBODIMENTS

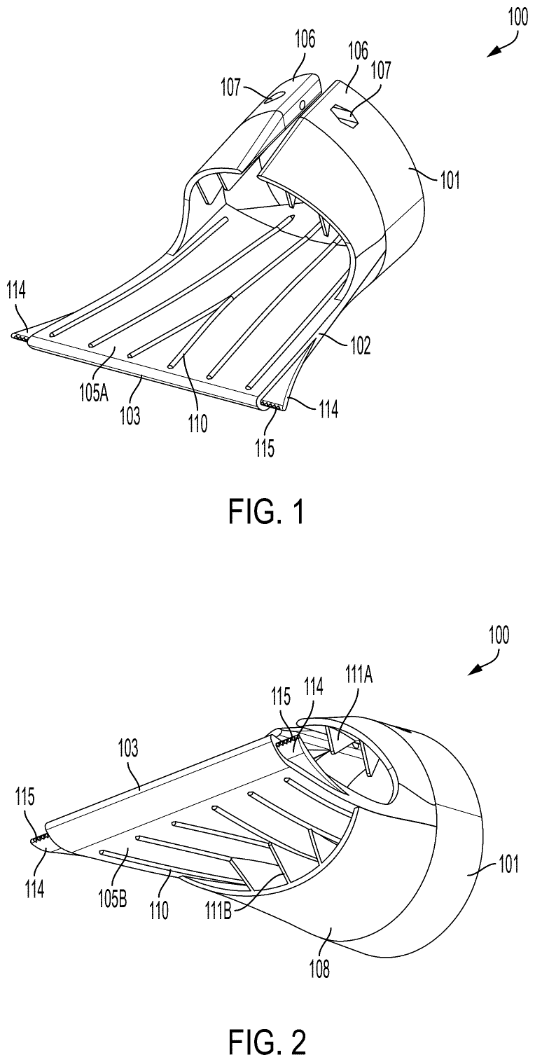

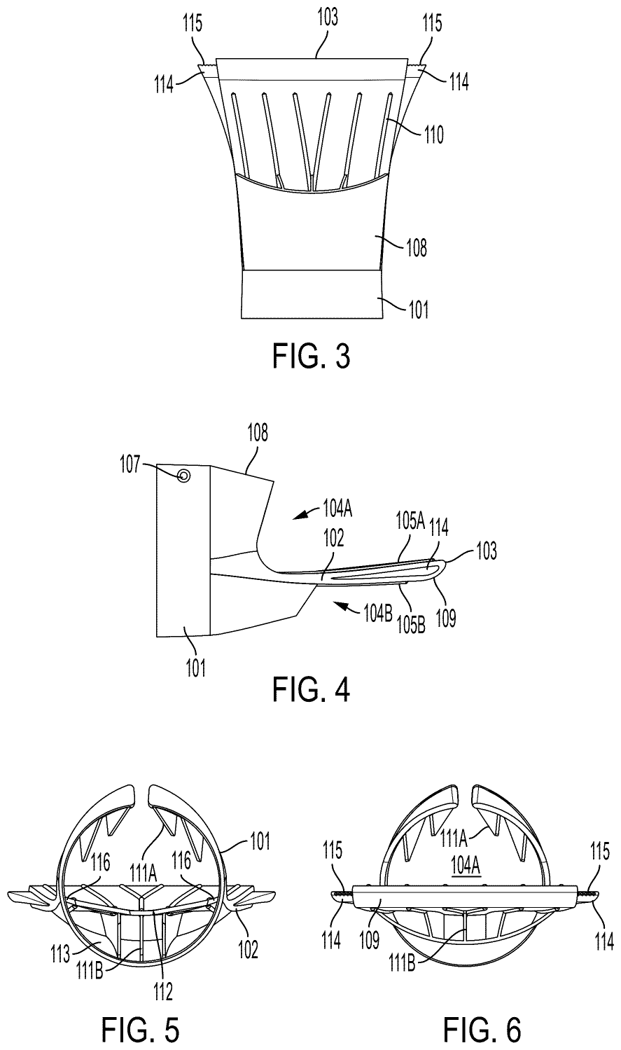

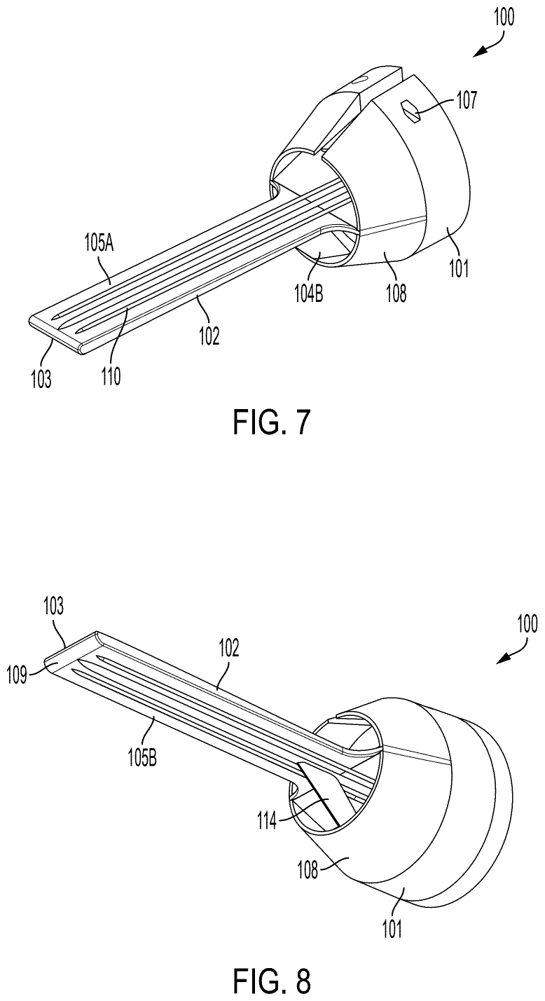

FIG. 1 shows a first embodiment of a nozzle 100 configured to attach to the distal end of a blower tube in use. The embodiment of FIG. 1 is designed for general use, whereas a second embodiment shown in FIG. 7 is specifically designed for clearing gutters.

The nozzle 100 may be monolithically formed as a single piece of plastic, such as from an injection moulding process. The nozzle 100 defines a collar 101, which is configured to attach to the open end of the blower tube in use. The nozzle 100 further defines a blade 102, which has a scraping edge 103. The scraping edge 103 is preferably straight. The blade 102 transects the collar 101 to form a first outlet 104A, shown in FIG. 4, and a second outlet 104B.

The outlets 104 direct streams of air along respective surfaces 105 of the blade 102. In use, when the nozzle 100 is attached to the open end of the blower tube, the scraping edge 103 may be used to scrape debris from surfaces that are difficult to dislodge using the cylindrical blower tube alone. The air streams emanating from both outlets 104 travel along respective surfaces 105 of the blade 102 and converge at the scraping edge 103, thereby facilitating the dislodgement of debris.

In the first embodiment, the first outlet 104A preferably has a larger cross-section than the second outlet 104B, so that air emanating from the blower tube predominantly travels across the top surface 105A of the blade 102. Furthermore, the nozzle 100 is typically attached to the end of the blower tube with the edge 103 of the blade 102 horizontal and with the larger first outlet 104A above the second outlet 104B. In this arrangement, the second outlet 104B ensures that a stream of air is directed under debris lifted by the scraping edge 103, further aiding dislodgement. Furthermore, the upper air stream keeps the upper surface 105A of the blade 102 free of debris.

As shown in FIG. 4, a second surface 105B of the blade 102 at the second outlet 104B (being the bottom surface 105B giving orientation described above) of the blade 102 may define a rounded aspect 109 adjacent to the scraping edge 103, which facilitates smoother movement across rough surfaces in use. An adjacent first surface 105A of the blade 102 (being a top surface 105A in the described orientation) may be predominantly planar. This configuration may also define an airfoiled cross-section evident from FIG. 4 that accelerates air along the second surface 105B, converging with the top stream at a different velocity and angle. This may induce turbulence at the scraping edge 103 and/or direct convergent air at an upward angle at the scraping edge 103 with respect to the first surface 105A of the blade 102.

As is evident from FIG. 4, the blade 102 at an angle towards the first outlet 104A with respect to the collar 101.

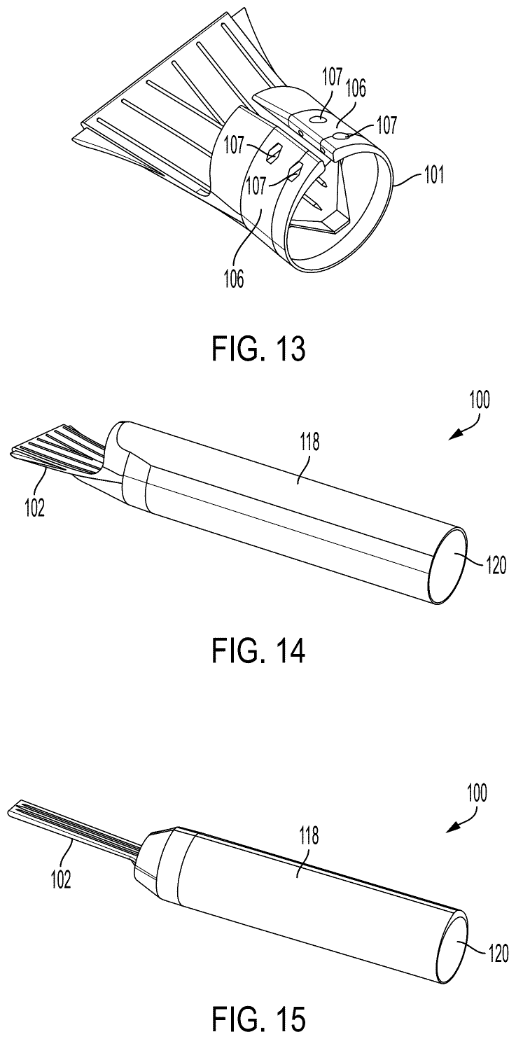

The collar 101 may be designed to clamp around the exterior distal end of the blower tube and may comprise adjustable bifurcated portions 106 defining aligned screw fastener apertures 107 for engaging a screw fastener used to pull the portions 106 together to clamp the portions 106 around the distal exterior surface of the blower tube. According to the embodiment of FIG. 1, the bifurcated portions 106 have a single pair of fastener apertures 107 therethrough whereas the embodiment of FIG. 13 shows the collar 101 having two pair of fastener apertures 107 for increased grip of the opening of the blower tube. FIG. 13 also illustrates the collar 101 may thicken at the fastener apertures 107 providing a greater body volume for accommodating and seating the screw fasteners therethrough. Each pair of fastener apertures 107, one may be cylindrical to rotatably contain a screw bolt and the other hexagonal to non-rotatably capture a corresponding hex nut.

With reference to FIG. 4, the nozzle 100 may define a funnel 108 funnelling accelerated streams of air against the surfaces 105 of the blade 102. At least one surface 105 of the blade 102 may comprise channelling formations 110, which channel the streams of air along the surfaces 105 of the blade 102. In the embodiment shown, the blade 102 widens from the collar 101 to the scraping edge 103, and the channel formations diverge to spread the streams of air across to the edges of the blade 102.

With reference to FIG. 5, the collar 101 may comprise internal vanes 111, which direct air across the blade 102. As is evident from FIG. 5, these vanes 111 may be directed to spread air across the widening blade 102. Second vanes 111B in the second outlet 104B may be connected between a proximal edge 112 of the blade 102 and an internal surface 113 of the collar 101, whereas first vanes 111A within the first outlet 104A may be triangular fins connected only to an interior surface of the collar 101, minimising airflow restriction within the top channel 104A. FIG. 5 shows that the first vanes 111A preferably intersect only the periphery of the first outlet 104A to minimise airflow restriction to minimise any backpressure effect on the blower.

With further reference to FIG. 5 an inner edge 112 of the blade 102 may be convex, thereby defining side notches 116 against the interior surface 113 of the collar 101 which engages respective edges of opposite sides of the blower tube, keeping the nozzle 100 in alignment with the blower tube during nozzle thereto or in use.

With reference to FIG. 1, sides of the blade 102 may define scraping edge projections 114, which can be used to scrape in narrow surface gaps or cracks when the nozzle 100 is turned sideways. With reference to FIG. 4, these scraping edge projections 114 may be relatively narrower than the remainder of the blade 102 to increase point pressure and may comprise a cross-section smaller but conforming in shape with the adjacent remainder of the blade 102. These scraping edge projections 114 may define forward-facing teeth 115 to facilitate scraping and debris dislodgement.

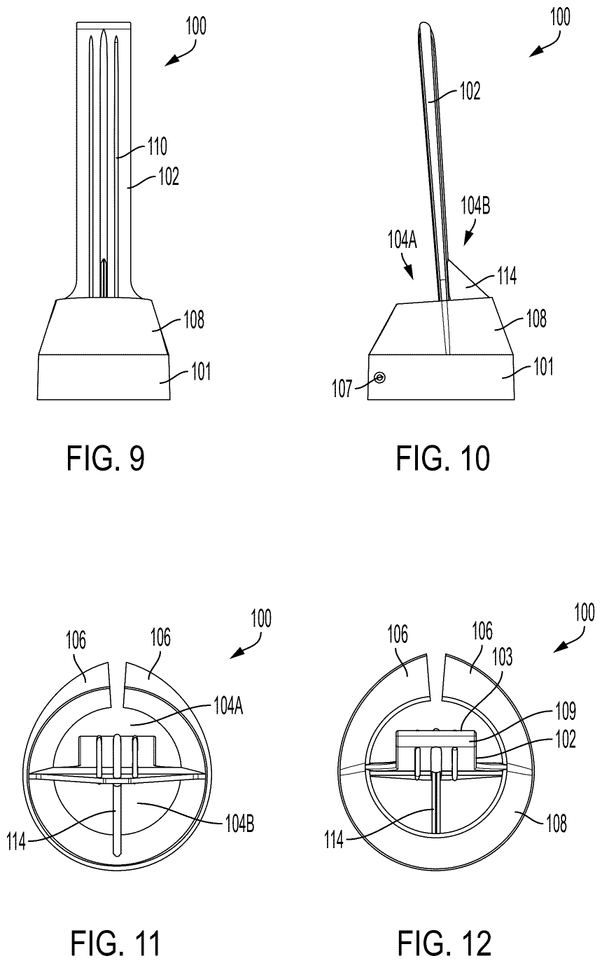

The embodiment of the nozzle 100 shown in FIGS. 7-12 is specifically designed for reaching into narrow gutters to dislodge accumulated debris. As such, the blade 102 is relatively longer and narrower and does not widen like the embodiment of FIG. 1. Correspondingly, the channelling formations 110 are parallel, directing air along the uniform width of the blade 102 towards the scraping edge 103. With reference to FIG. 8, the blade 102 may similarly comprise the underside rounded aspect 109 adjacent to the scraping edge 103.

Furthermore, the nozzle 100 in accordance with this embodiment may similarly comprise the funnel 108 funnelling accelerated air streams against the surfaces 105 of the blade 102. The nozzle may comprise an aerodynamic stay 114, which braces the blade 102 with respect to the collar 101 but which is orientated edge on to the second outlet 104B to minimise airflow restriction. The stay 114 may be located only in the second outlet 104B to withstand upward bending force and avoid airflow obstruction of the first outlet 104A.

With reference to FIG. 11, the first outlet 104A may have substantially the same cross-section as the second outlet 104B. With reference to FIG. 10, the blade 102 may also be angled up with respect to the collar 101 towards the first outlet 104A and away from the second outlet 104B.

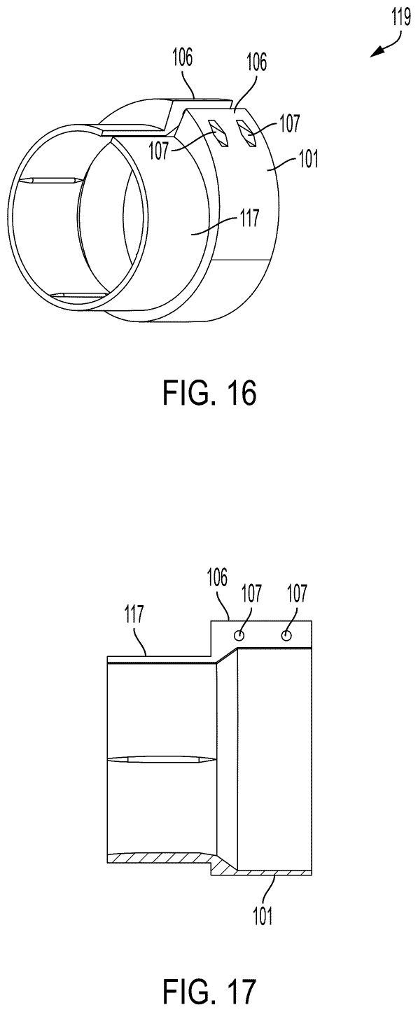

FIGS. 16 and 17 show an adapter 119 in accordance with an embodiment similarly comprising the aforedescribed collar 101 having bifurcated portions 106, fastener apertures 107 therethrough and which may widen at the fastener apertures 107. The adapter 119 further comprises a cylindrical portion 117. In use, the collar 101 of the adapter 119 may be tightened around the open end of the blower tube using screw fasteners through the fastener apertures 107 to expose the cylindrical portion 117 for replaceable attachment of nozzle pieces having corresponding profiles. The cylindrical portion 117 itself may be bifurcated in continuance of the bifurcated portions 106 of the collar 101 thereby allowing it to adjust to the tightening or loosening of the collar 101.

FIGS. 14 and 15 show an embodiment of the nozzle comprising an elongate tube 118 preceding the blade 102 for the aforedescribed first and second embodiments respectively. Preferably, the elongate tube 118 is much longer than the blade 102 as is evident from these figures. A cylindrical open end 120 of the tube 118 may be secured around the collar 117, wherein the elongate tube 118 thereby extends the effect of reach of the blade 102.

A rubber band may envelop the cylindrical portion 117 or the interior of the opening 120 to secure the tube 118 to the collar 117 allowing for tool free interchange of tubes 118.

FIG. 17 further shows how the adapter may diminish in cross-section from the collar 101 to the cylindrical portion 117, thereby accelerated air therethrough.

To use the nozzle 100, according to the embodiment shown in FIG. 1, the operator first ensures the blower tube is clean and free of any obstructions. The collar 101 of the nozzle 100 is then aligned with the distal end of the blower tube. The operator clamps the collar 101 around the blower tube by tightening the screw fasteners through the aligned apertures 107, ensuring a secure fit. This configuration allows the nozzle 100 to channel the air flow from the blower tube effectively through the outlets 104A and 104B.

In operation, the blower is activated, and air is propelled through the nozzle 100. The first outlet 104A, having a greater cross-section than the second outlet 104B, directs a predominant stream of air along the top surface 105A of the blade 102. Simultaneously, the second outlet 104B directs a stream of air along the bottom surface 105B of the blade 102. The combined air streams converge at the scraping edge 103, creating a focused flow that facilitates debris removal.

To clear debris from a surface, the operator positions the scraping edge 103 against the surface and moves the blower in a direction that allows the edge to scrape and lift debris. The air streams from the outlets 104A and 104B work to dislodge and blow away the debris. The second outlet 104B directs air underneath the lifted debris, aiding in the removal process.

When addressing surfaces with gaps or cracks, the operator can turn the nozzle 100 sideways, using the scraping edge projections 114 to target and remove debris from narrow spaces. The forward-facing teeth 115 on the projections 114 enhance the scraping action, making it more effective in tight areas.

For gutter cleaning, using the nozzle 100 according to the second embodiment of FIGS. 7-12, the operator attaches nozzle 100 to the blower tube in the same manner. This embodiment, with its longer and narrower blade 102, is designed to reach into gutters. The parallel channelling formations 110 direct air along the blade 102 towards the scraping edge 103, ensuring effective debris removal within the confined space of a gutter.

The operator guides the nozzle 100 along the length of the gutter, allowing the scraping edge 103 to lift and dislodge accumulated debris. The air streams from the outlets 104A and 104B work to blow the dislodged debris out of the gutter. The aerodynamic stay 114, located in the second outlet 104B, provides stability and prevents upward bending of the blade 102 during use.

The nozzle according to the embodiment of FIG. 13 comprising two pairs of fastener apertures 107 may be used to provide increased clamping engagement with the blower tube. These apertures 107 may be reinforced by thickened collar portions to accommodate and seat screw fasteners securely, with one aperture optionally cylindrical to rotatably contain a screw bolt and the other hexagonal to non-rotatably capture a corresponding nut.

In certain scenarios, the adapter 119, shown in FIGS. 16 and 17, may be used in conjunction with the nozzle 100, allowing a cylindrical portion 117 to project from the collar 101 for interchangeable engagement with a variety of nozzle heads or elongate tubes 118. This cylindrical portion 117 may itself be bifurcated, permitting deformation in response to tightening of the collar 101, thereby ensuring secure tool-free attachment of nozzle accessories. A rubber band or other elastic coupling may be applied over the cylindrical portion 117 or within the tube 118 to maintain connection under airflow pressure. The adapter 119 may taper inwardly from the collar 101 to the cylindrical portion 117, thus accelerating the air passing therethrough.

In other scenarios, the nozzle 100 of FIGS. 14 and 15 having the elongate tube 118 preceding the blade 102 may be used to significantly increasing reach and enabling access to elevated or deep-set surfaces. This configuration is especially beneficial when targeting distant debris or when the operator must maintain clearance from the surface being cleaned.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A nozzle comprising:
a collar configured to attach to a distal end of a blower tube; and
a blade defining a scraping edge and transecting the collar to form top and second outlets that direct respective streams of air along both surfaces of the blade.

2. The nozzle according to claim 1, wherein the first outlet has a greater cross-section than the second outlet.

3. The nozzle according to claim 1, wherein a second surface of the blade at the second outlet adjacent to the scraping edge is rounded.

4. The nozzle according to claim 3, wherein a first surface of the blade at the first outlet is planar.

5. The nozzle according to claim 1, wherein the collar consists of bifurcated portions.

6. The nozzle according to claim 1, wherein the nozzle defines a funnel downstream of the collar configured for funnelling accelerated streams of air against the surfaces of the blade.

7. The nozzle according to claim 1, wherein at least one surface of the blade comprises channelling formations.

8. The nozzle according to claim 7, wherein a width of the blade increases towards the scraping edge and wherein the channel formations are splayed sideways towards the scraping edge.

9. The nozzle according to claim 1, wherein the collar comprises internal vanes which direct air across the blade.

10. The nozzle according to claim 9, wherein a width of the blade increases towards the scraping edge and wherein the internal vanes are configured to spread air sideways towards the scraping edge.

11. The nozzle according to claim 9, wherein the second outlet comprises vanes connected between a proximal edge of the blade and an interior surface of the collar.

12. The nozzle according to claim 9, wherein the first outlet comprises vanes connected only to an interior surface of the collar.

13. The nozzle according to claim 1, wherein side edges of the blade adjacent to the scraping edge define scraping edge projections.

14. The nozzle according to claim 13, wherein the scraping edge projections have cross-sections proportional to an adjacent cross-section of the blade.

15. A system comprising:
a nozzle comprising a blade forming top and second outlets that direct respective streams of air along both surfaces of the blade; and
an adapter comprising:
a collar configured to attach to a distal end of a blower tube; and
a cylindrical portion extending from the collar and configured for interchangeable attachment of the nozzle.

16. The nozzle according to claim 15, wherein the cylindrical portion is bifurcated in continuation with of bifurcated portions of the collar.

17. A method of using the nozzle of claim 1 with a blower tube, the method comprising the steps of:
attaching a collar of the nozzle to a distal end of the blower tube;
activating the blower to propel air through the nozzle, thereby directing air through top and second outlets formed by a blade transecting the collar and creating respective streams of air along both surfaces of the blade;
positioning a scraping edge of the blade against a surface to lift and dislodge debris; and
utilising the air streams to blow the dislodged debris away from the surface.

18. A method of using the system of claim 15, the method comprising attaching the collar of the adapter to a distal end of a blower tube and securing the nozzle to the cylindrical portion of the adapter.

19. The method of claim 18, further comprising tightening the collar to compress the bifurcated cylindrical portion and thereby retain the nozzle.

20. The method of claim 18, further comprising accelerating airflow through the adapter by directing it through a tapering cross-section of the cylindrical portion.
